(19) United States
(12) Patent Application Publication
(10) Pub. No.: US 2004/0070125 A1
(43) Pub. Date: Apr. 15, 2004

(54) Liquid-sealed vibration-proof device

(76) Inventors: Osamu Nakagaki, Ichinomiya-shi (JP); Tatsuo Suzuki, Inazawa-shi (JP); Norihiro YAMADA, Inazawa-shi (JP); Tetsuo Asano, Komaki-shi (JP); Keiji Miyoshi, Inazawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/425,919

(22) Filed: Apr. 30, 2003

Related U.S. Application Data
(63) Continuation-in-part of application No. 09/493,651, filed on Jan. 28, 2000, now abandoned.

(30) Foreign Application Priority Data
Mar. 18, 1999 (JP) 11-072973
Aug. 23, 1999 (JP) 11-235460

(51) Int. Cl. F16M 5/00

(52) U.S. Cl. 267/140.14

(57) ABSTRACT

To eliminate vibrations and noise in higher-order components of explosive vibrations of an engine in its idling revolution range, an insulator and a vibration-absorbing mechanism formed in line with the insulator are provided between an upper coupling member to be mounted on a vibratory body and a lower coupling member to be mounted on the car body. The vibration-absorbing mechanism comprises a main chamber sealed with liquid, a subsidiary chamber connected to the main chamber through a first orifice, an air chamber provided below the subsidiary chamber, a third liquid chamber connected to the main chamber through a second orifice, and a balance chamber partitioned and formed to the third liquid chamber through a second diaphragm. The balance chamber is provided with a changeover means introducing a negative pressure or atmospheric pressure and a control means controlling the actuation of the changeover means so as to synchronize it to vibration frequencies of higher-order components.

### RELATED APPLICATIONS

This application is Continuation-in-Part of U.S. patent application Ser. No. 09/493,651, filed Jan. 28, 2000, which claims priority to Japanese Patent Application 11-072973, filed Mar. 18, 1999, and to Japanese Patent Application No. 11-235460, filed Aug. 23, 1999. The contents of all of these applications are hereby incorporated by reference in their entirety.

### BACKGROUND OF THE INVENTION

1. Field of the Invention

This invention relates to a liquid-sealed vibration-proof device constructed so that a vibration-proof effect can be obtained on the basis of the fluidization of fluid (liquid) sealed internally. More particularly, it is concerned with a liquid-sealed type of vibration-proof device, wherein vibration-absorbing characteristics exhibited attendant upon fluidization of the liquid can be changed over in plural tiers with an exciting device driven by a negative intake pressure of an engine and to that end, changeover means may be actuated in a state synchronized to frequencies of other orders than a first-order frequency of explosive vibrations of the engine in its idling revolution number range.

2. Description of Related Art

Of vibration-proof devices, among others, an automotive engine mount must meet a wide range of frequencies, since the engine as a power source is used in various situations covering from an idling drive condition to a maximum rotation speed. In order to meet plural conditions like this, such a mount is known that is internally provided with a liquid chamber and further provided with an exciting device exciting the liquid inside at a particular frequency. In this instance, as the exciter, there is enumerated the one constructed of a simple mechanism driven at a negative intake pressure of the engine. A mount constructed so as to achieve isolation of various vibrations as well as engine idling vibrations by actuating such an exciter of negative intake pressure driving type has been already invented by the present inventors and published in JP Patent-A-10-184775 (1997).

With the aforementioned known mount, in cases where the engine idling revolution number is in a relatively low revolution number range, even if the exciter is actuated in a state synchronized to the engine idling vibration, a problem arises in that actually, the cabin noise or vibrations are not so reduced as expected. This is supposed to be ascribable to the fact that vibrations and noise resonated with a second-order or a third-order component of the engine explosive vibrations are generated in the cabin (see FIG. 4).

Accordingly, it is an object (problem) of this invention to provide a liquid-sealed vibration-proof device that is constructed to be able to reduce vibrations and noise ascribed to higher-order vibrations such as the second-order or third-order vibration.

### SUMMARY OF THE INVENTION

In order to solve the problem, this invention is designed to take the following expedient. That is to say, according to an invention as set forth in claim 1, a liquid-sealed vibration-proof device of an excitation type is provided, which comprises a first coupling member to be mounted to a vibratory body (e.g., an engine); a second coupling member to be mounted to a car body-side member or the like; an insulator absorbing and insulating vibrations from the vibratory body and interposed between the first coupling member and the second coupling member; a main chamber having a chamber wall formed by a part of the insulator and sealed with liquid, a subsidiary chamber connected to the main chamber through a first orifice and partly formed by a first diaphragm, a third liquid chamber connected to the main chamber through a second orifice and formed so that the liquid within the main chamber may be introduced therein, and a balance chamber partitioned through a second diaphragm to the third liquid chamber and formed so that either of a negative pressure and atmospheric pressure may be introduced therein. And the balance chamber is provided with changeover means actuating to change over to either of the negative pressure and atmospheric pressure continuously or alternately at a specified frequency, and control means controlling the changeover actuation of the changeover means, the control means being operated in the condition that an idling revolution range of the engine is divided into a low revolution number range and a high revolution number range on the basis of a predetermined conversion point, the control means performing a control so as to vibrate the second diaphragm in a state synchronized to frequencies of other orders than a first-order frequency of engine explosive vibrations in the aforesaid low revolution number range. By adopting the construction like this, according to this invention, a dynamic spring constant of the entirety of the liquid-sealed vibration-proof device can be reduced in a higher-order frequency range than a second-order frequency. As a result, vibrations and noise in the cabin ascribed to higher-order vibrations than the second-order frequency will be diminished. Hence it becomes possible to reduce overall levels of vibrations and noise.

An invention as set forth in claim 2 will be described as follows: Its fundamental features are the same as those of the invention according to claim 1. Its characterizing feature is in performing the control of the changeover means by dividing the engine idling revolution number range into the relatively low revolution number range and the relatively high revolution number range such as upon idling-up. That is, the invention of claim 2 is concerned with a liquid-sealed vibration-proof device which comprises a first coupling member to be mounted to a vibratory body; a second coupling member to be mounted to a car body-side member or the like; an insulator absorbing and insulating vibrations from the vibratory body and interposed between the first coupling member and the second coupling member; a main chamber having a chamber wall formed by a part of the insulator and sealed with liquid, a subsidiary chamber connected to the main chamber through a first orifice and partly formed by a first diaphragm, a third liquid chamber connected to the main chamber through a second orifice and formed so that the liquid within the main chamber may be introduced therein, and a balance chamber partitioned through a second diaphragm to the third liquid chamber and formed so that either of a negative pressure and atmospheric pressure may be introduced therein, wherein the balance chamber is provided with changeover means actuating to change over to either of the negative pressure and the atmospheric pressure continuously or alternately at a specified frequency, and control means controlling the changeover actuation of the changeover means, the control means being operated in the condition that an idling revolution range of an engine is divided into a low revolution number range and a high revolution number range on the basis of a predetermined conversion point, the control means performing a control action according to map control so as to vibrate, in the aforesaid high revolution number range, the second diaphragm in a state synchronized to the vibration frequencies of other orders than the first-order frequency of engine explosive vibrations and so as to vibrate, in the aforesaid low revolution number area, the second diaphragm in a state synchronized to the vibration frequencies of other orders than the first-order frequency of the engine explosive vibrations. By adopting the construction above, in a case where the engine idling revolution number is in a relatively low revolution number range, it is possible to diminish vibrations and noise ascribed to the second-order component whereas in a range where the engine idling revolution number becomes high, for example by idling up, it is possible to reduce vibrations and noise ascribed to the first-order component. As a result, vibrations and noise over an entire range of idle revolution numbers can be reduced (cf. FIG. 3).

### BRIEF DESCRIPTION OF THE DRAWINGS

Embodiments of the invention will be hereinafter described in more detail with reference to the accompanying drawings, in which

FIG. 1 is a longitudinal sectional view showing an overall construction of the invention;

FIG. 2A, FIG. 2B and FIG. 2C are graphical representations each showing an example where the input of vibrations containing higher-order components is diminished;

FIG. 3 is a graph showing vibration characteristics in this invention; and

FIG. 4 is a graph showing vibration characteristics in the conventional example.

### DESCRIPTION OF THE PREFERRED EMBODIMENTS

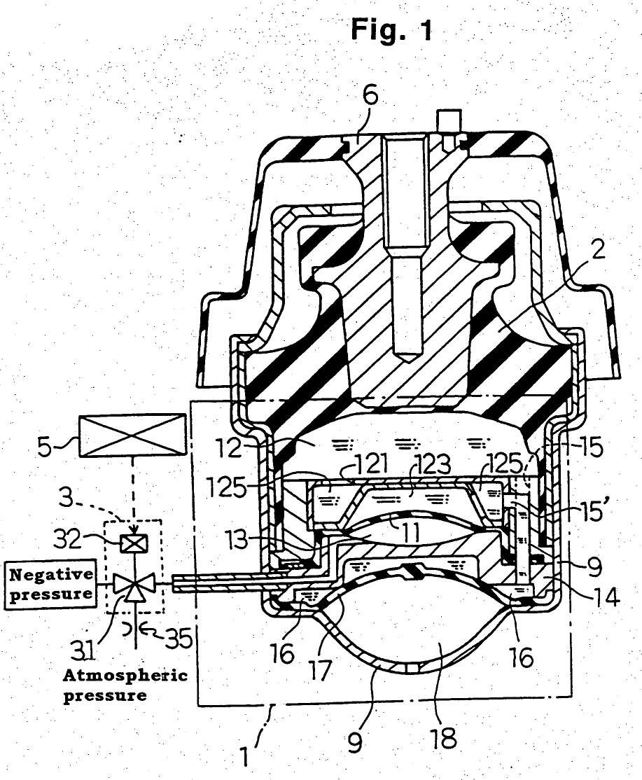

One embodiment of this invention will be described with reference to FIGS. 1 to 3. The construction of this embodiment according to the invention basically comprises, as illustrated in FIG. 1, an upper coupling member 6 constituting a first coupling member to be mounted on a vibratory body; a lower coupling member 9 constituting a second coupling member to be mounted on a car body-side member; an insulator 2, located between these upper and lower coupling members 6 and 9, for absorbing and insulating vibrations from the vibratory body; a vibration-absorbing mechanism 1 provided in line with the insulator 2 and including a main chamber 12 sealed with liquid as a non-compressive fluid and a subsidiary chamber 16, and a first orifice 15 (shown in the dot line in FIG. 1) interconnecting the main chamber 12 and the subsidiary chamber 16 and through which to fluidize the liquid; a balance chamber 13 constituting a part of the vibration-absorbing mechanism 1 and formed by partitioning through a second diaphragm 11 between it and a third liquid chamber 123, the balance chamber including a changeover means 3 actuating to change over so as to introduce either of a negative pressure and atmospheric pressure continuously or alternately at a particular frequency and a control means 5 controlling the changeover actuation of the changeover means 3.

In the embodiment thus fundamentally constructed, the aforementioned insulator 2 is made of a rubber-like elastomer such as a vibration-insulating rubber material, etc. and integrally bonded at its one edge surface to the upper coupling member 6 by vulcanization adhesion means or the like. The vibration-absorbing mechanism 1 in line with the insulator 2 is provided contiguously with the insulator 2 below it. The vibration-absorbing mechanism 1 comprises a main chamber 12 sealed with liquid, a third liquid chamber 123 connected through a second orifice 125 to the main chamber 12 and formed so that the liquid in the main chamber 12 may be introduced therein, a balance chamber 13 formed by partitioning to the third liquid chamber 123 through a second diaphragm 11 and introducing therein a negative pressure or atmospheric pressure, a subsidiary chamber 16 provided through a partition plate 14 to the main chamber 12 and sealed with liquid, like the main chamber 12, a first orifice 15, 15′ interconnecting the main chamber 12 and the subsidiary chamber 16, and an air chamber 18 provided below the subsidiary chamber 16 through a first diaphragm 17 and introducing always therein atmospheric air.

The construction of the second diaphragm 11 and its surrounding forming the vibration-absorbing mechanism 1 thus constructed will be described. That is, the second diaphragm 11 is provided between the third liquid chamber 123 communicating with the main chamber 12 and the balance chamber 13 in which a negative pressure or atmospheric pressure is introduced. At the one surface side thereof (the upper side), the liquid in the main chamber 12 is to be introduced through the second diaphragm 125 with a predetermined volume, and the third liquid chamber 123 is formed so that fluctuation in hydraulic pressure in the main chamber 12 may be always propagated thereto. At the other side of the second diaphragm 11 (the lower side), the balance chamber 13 is provided, in which negative pressure or atmospheric pressure is to be introduced on the basis of the actuation of the changeover means 3.

The changeover means 3, which actuates to introduce the negative pressure or atmospheric pressure appropriately changed over into the balance chamber 13, includes a changeover valve 31 such as a three-way valve, etc. and a solenoid 32 driving the changeover valve 31. At a port side of the changeover valve 31 thus constructed for introducing the atmospheric pressure, there is provided a throttle valve 35 for adjusting to balance the introduction speed of the atmospheric pressure to the introduction speed of the negative pressure.

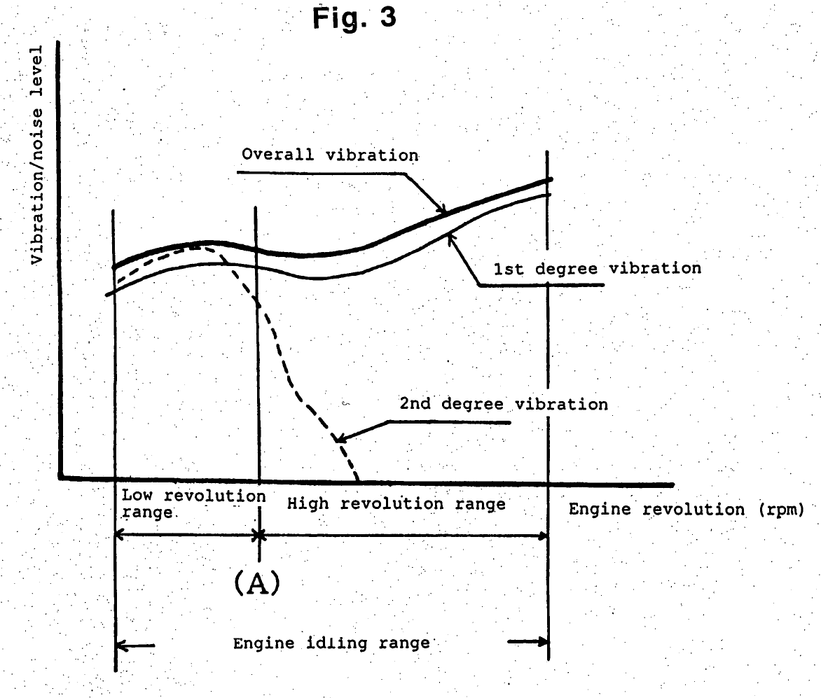

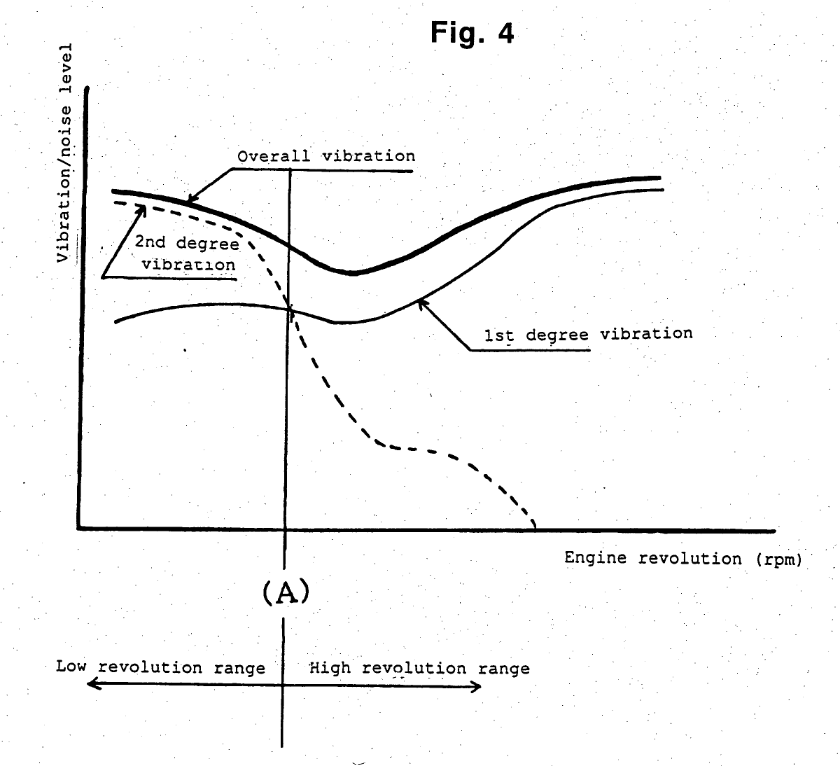

The control means 5 controlling the changeover actuation of the changeover means 3 as constructed above includes a microcomputer formed on the basis of operational means such as a micro-processor unit (MPU) and serves to control the changeover actuation of the changeover means 3 mainly by the map control. More specifically, the control means 5 is adapted to control under the condition that the engine idling revolution number range is divided into a low revolution number range and a high revolution number range on the basis of a conversion point (A) as shown in FIGS. 4 and 3.

Now the operation mode of this embodiment so far described will be described. Vibrations from the vibratory body side are propagated, as shown in FIG. 1, via the upper coupling member 6 to the insulator 2 of a rubber material, etc. Attendant on this, the insulator 2 vibrates or deforms to absorb or insulate most of the input vibrations. Consequently, a majority of the vibrations are to be insulated at the insulator 2 whereas a part of them is not insulated there, but is to be insulated at the vibration-absorbing mechanism 1, which is the next to the insulator.

More specific actions of the vibration-absorbing mechanism 1 will be hereinafter described. Engine shake having vibration of a low frequency of the order of 10 Hz is inhibited (damped) by a damping force based on the fluidization action of the liquid within the first orifice 15 (illustrated in the dot line in FIG. 1). As regards vibrations in an idling revolution number range, the changeover means 3 is actuated to introduce alternately a negative pressure or atmospheric pressure at a particular frequency into the balance chamber 13. Stated another way, by the actuation of the changeover means 3 at a particular frequency, the pressure (volume) within the balance chamber 13 is changed, whereby a hydraulic change in the main chamber 12 caused by the idling vibrations input through the insulator 2 is absorbed by the operation of the third liquid chamber 123 and the second orifice 125.

Here, in particular, because the third liquid chamber 123 is provided to be connected to the main chamber 12 through the second orifice 125 having a predetermined volume so as to change its volume in conformity with the hydraulic pressure of the liquid in the main chamber 12, when the second diaphragm 11 is actuated attendant upon the actuation of the balance chamber 13, this actuation (vibration) is propagated via the third liquid chamber 123 and the second orifice 125 to the liquid within the main chamber 12. At that time, the liquid within the second orifice 125 interconnecting the third liquid chamber 123 and the main chamber 12 resonates with the volume change in the balance chamber 13. As a result, in the particular frequency range (range of vibration frequency number) of the engine idling revolution range, the dynamic spring constant at this vibration-absorbing mechanism 1 is significantly reduced. This reduction or diminishment in dynamic spring constant enables each vibration and noise in the engine idling range to be efficiently absorbed or insulated.

In this liquid-sealed type vibration-proof device, above all, an engine mount device, for example, constructed so that the first orifice 15′ and the second orifice 125 are provided in line with each other as shown in FIG. 1 is conceivable. That is, in the conceivable engine mount device, the second orifice 125 and the first orifice 15′ are provided in line between the main chamber 12 and the subsidiary chamber 16 so that the exciting force may be propagated from the third liquid chamber 123 to both orifices 15′ and 125. Further in this mount device, diameters (A) and lengths (L) of the respective orifices 125 and 15′, namely the (A/L) ratios (alpha, beta) of the first orifice 15′ and the second orifice 125 are set: alpha=2.87 and beta=1.43, and the beta/alpha ratio value is set to be 0.50. Here, in addition to the aforementioned beta/alpha value, the ratio of A/L value (beta) of the second orifice 125 to A/L value (alpha) of the first orifice 15′ may be chosen, for example, in the range of 0.3 to 2.0, whereby a preferred result (coupled effect) can be obtained. More preferably, the ratio is 0.4 to 1.0.

By adopting the construction like this, in this embodiment, to meet the idling vibrations, a exciting force caused in the third liquid chamber 123 is amplified owing to the resonance action of the first orifice 15′ and propagated to the main chamber 12. More specifically, the exciting force (generated force) generated in the third liquid chamber 123 by the oscillation of the second diaphragm 11 is first propagated to the second orifice 125 and further propagated to the main chamber 12 and the first orifice 15′.

The pressure (exciting force) propagated on the first orifice 15′ in this embodiment is amplified, receiving the resonance action at the first orifice 15′ because of the fact that the first orifice 15′ is configured to be tuned as described above. As a result, in this embodiment, the exciting force propagated to the insulator 2 is increased or amplified. In this way, the dynamic spring constant value (Kd) is lowered, and simultaneously, the exciting force is increased or amplified, whereby it is possible to regulate the values of dynamic spring constant and damping coefficient within a targeted range for the control purposes of this engine mounting system. Therefore the absorption and insulation of idling vibrations in this engine mounting system can be more efficiently achieved.

Meanwhile, insofar as the operation of the vibration-absorbing mechanism 1 in the engine idling revolution range is concerned, it is constituted in this embodiment so that under the condition that the engine idling revolution range is divided into a low revolution number range and a high revolution number range at the basis point of a conversion point (A) as indicated in FIGS. 3 and 4, individual controls in the aforementioned respective ranges may be performed. The individual controls are conducted according to a predetermined map control method. In general, in the engine idling revolution range, in particular, in its low revolution number range, the levels of vibrations and noise are high, for example, for the reason that a steering system resonates with the second-order frequency of engine explosive vibrations, and other thing. And these levels of vibrations and noise are abruptly lowered from this boundary of the conversion point (A). Diminishing the vibrations-noise levels of this second-order vibration component is required in diminishing levels of overall vibrations and noise. On the other hand, in the high revolution number range beyond the conversion point (A), the vibration levels ascribed to the first-order component (vibration) of engine explosive vibrations are high (see FIG. 4). As a consequence, in this range, it is necessary to excite the second diaphragm 11 so as to resonate with the first-order frequency of the engine explosive vibrations.

Taking these things into account, in this embodiment, the second diaphragm 11 and the changeover valve 31 of the changeover means 3 are operated first in the low revolution number range, bordering on the conversion point (A) in FIG. 3, while resonating with the second-order frequency (f2) of the engine explosive vibrations. Thereby the dynamic spring constant of this liquid-sealed type vibration-proof device will be reduced against the input of vibrations having a natural frequency of the second-order frequency (f2). In the high revolution number range, on the other hand, the second diaphragm 11 and the changeover valve 31 of the changeover means 3 are actuated, while synchronizing with the first-order frequency (f1) of the engine explosive vibrations. As a consequence, against the input of vibrations having a natural frequency of the first-order frequency (f1), the dynamic spring constant of this liquid-sealed type vibration-proof device will be reduced, and the vibration having this frequency (f1) will be insulated at this liquid-sealed vibration-proof device. The two-tier control bordering on the conversion point (A) is conducted on the basis of data (map data) preliminarily input in a ROM means constituting the control means 5. By conducting the control like this, it is possible to reduce levels of the vibrations and noise in the overall engine idling revolution range.

Instead of the map control method as described above, it may be possible to operate the second diaphragm 11 and the changeover valve 31 of the changeover means 3 only in the low revolution number range, while synchronizing with the second-order frequency (f2) of the engine explosive vibrations. This is possible by setting the ROM data of the control means 5 in such a way. In this case, in the high revolution number range, the rubber characteristic of the insulator 2 is preliminarily set so that its dynamic spring constant may be reduced against the first-order frequency (f1) of the engine explosive vibrations. By setting in this manner, it is possible to reduce the dynamic spring constant of this liquid-sealed vibration-proof device relative to a specified frequency (number of vibration frequency) over the entire engine idling revolution range, without adopting the map control. The levels of vibrations and noise can be reduced therefore over the entire engine idling range (cf. FIG. 3).

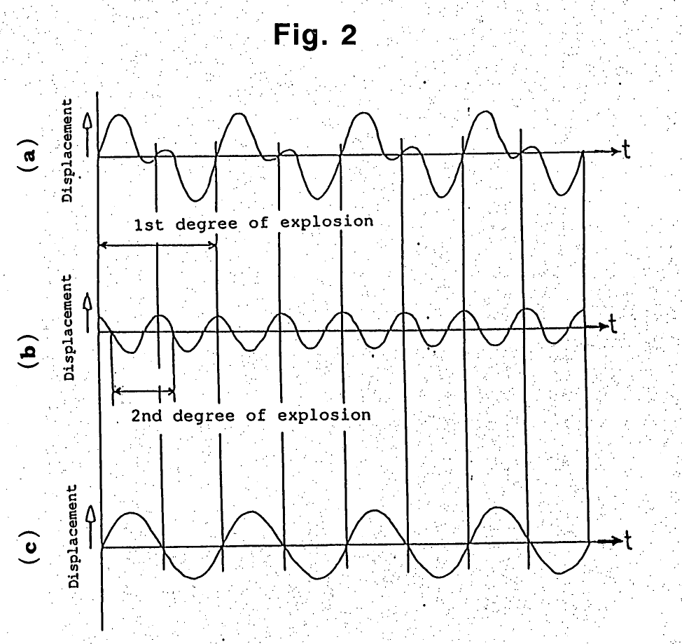

A specific control method (vibration-damping method) in cases where the steering system resonates with the second-order frequency (f2) of the engine explosive vibrations will be described in more detail with reference to FIGS. 2A, 2B and 2C. Here, the oscillation waves actually generated are compounded, as shown in FIG. 2A, by the first-order frequency (natural frequency: f1) and the second-order frequency (natural frequency: f2) ascribed to the engine explosive vibrations. Of these, the one having the natural frequency of f2, which is the second-order component, is higher in level of vibrations and noise (see FIG. 4). Accordingly, it is necessary to reduce vibrations of the second-order component. In order to cope with this, the second diaphragm 11 and the changeover means 3 are operated in a state synchronizing with the number of vibration frequency (frequency) of f2 as shown in FIG. 2B. This reduces the level of vibrations and noise ascribed to the vibrations of the second-order component down to the level indicated in the dot line in FIG. 3.

As a result, there remain vibrations of the first-order component behind as shown in FIG. 2C. The levels of vibrations and noise of the first order component are however not so high, as indicated in the thin line in FIG. 3 that the entire levels of vibrations and noise will be reduced as shown in the bold line in FIG. 3. Further as regard the vibrations of the first-order component, these can be absorbed or insulated by appropriately adjusting the dynamic spring constant of the insulator 2. It is also possible to cope with them according to the map control by operating the second diaphragm 11 and the changeover means 3 so as to synchronize with the first-order vibrations (natural frequency: f1) of engine explosive vibrations in the range where the engine idling revolution number becomes high (the high revolution number range).

According to this invention thus described above, the liquid-sealed type vibration-proof device is constructed generically so that it comprises the first coupling member to be mounted to a vibratory body; the second coupling member to be mounted to a car body-side member or the like; the insulator absorbing and insulating vibrations from the vibratory body and interposed between the first coupling member and the second coupling member; the main chamber having a chamber wall formed by a part of the insulator and sealed with liquid, the subsidiary chamber connected to the main chamber through the first orifice and partly formed by the first diaphragm, the third liquid chamber connected to the main chamber through a second orifice and formed so that the liquid within the main chamber may be introduced therein, and a balance chamber partitioned through a second diaphragm to the third liquid chamber and formed so that either of a negative pressure and atmospheric pressure may be introduced therein. And it is characterized in that the balance chamber is provided with changeover means actuating to changeover to either of the negative pressure and the atmospheric pressure continuously or alternately at a specified frequency, and control means controlling the changeover actuation of the changeover means, the control means being operated under the condition that an idling revolution range of an engine is divided into a low revolution number range and a high revolution number range on the basis of a predetermined conversion point, the control means performing a control operation so as to vibrate the second diaphragm in a state synchronized to vibration frequencies of other orders than a first-order frequency of engine explosive vibrations in the low revolution number range. Because of the construction thus adopted, it becomes possible to reduce vibrations and noise within the cabin ascribed to higher-order vibrations of the engine explosive vibrations. As a consequence, a reduction in level of entire vibrations and noise can be achieved.

Otherwise, the actuation control of the second diaphragm and the changeover means is conducted according to the map control method, wherein the control is based on the map provided in the control means. That is, the control is performed under the condition that the engine idling revolution range is divided into a low revolution number range and a high revolution number range, bordering on a conversion point, so as to eliminate vibrations of higher-order components other than the first-order component of the engine explosive vibrations in the aforesaid low revolution number range while so as to eliminate the vibrations of the first-order component in the aforesaid high revolution number range. Therefore also in a range where the engine idling revolution number becomes high owing to idling up, etc., a reduction in vibrations and noise ascribed to the first-order component can be achieved. As a consequence, it becomes possible to reduce the vibrations and noise over the entire idling revolution range.

What is claimed is:

1. A liquid-sealed vibration-proof device comprising
a first coupling member to be mounted to a vibratory body;
a second coupling member to be mounted to a car body-side member or the like;
an insulator absorbing and insulating vibrations from the vibratory body and interposed between the first coupling member and the second coupling member;
a main chamber, whose wall is formed by a part of the insulator and in which liquid is sealed, a subsidiary chamber connected to the main chamber through a first orifice and partly formed by a first diaphragm, a third liquid chamber connected to the main chamber through a second orifice and formed so that the liquid within the main chamber may be introduced therein, and a balance chamber partitioned through a second diaphragm to the third liquid chamber and formed so that either of a negative pressure and atmospheric pressure may be introduced therein;
wherein the balance chamber is provided with changeover means actuating to change over to either of the negative pressure and atmospheric pressure continuously or alternately at a particular frequency, and control means controlling the changeover actuation of the changeover means,
the control means being operated under the condition an idling revolution range of an engine is divided into a low revolution number range and a high revolution number range on the basis of a predetermined conversion point, the control means performing a control action so as to vibrate the second diaphragm in a state synchronized to the vibration frequencies of other orders than a first-order frequency of engine explosive vibrations in said low revolution number range.

2. A liquid-sealed vibration-proof device comprising
a first coupling member to be mounted to a vibratory body;
a second coupling member to be mounted to a car body member or the like;
an insulator absorbing and insulating vibrations from the vibratory body and interposed between the first coupling member and the second coupling member;
a main chamber, whose wall is formed by a part of the insulator and in which liquid is sealed, a subsidiary chamber connected to the main chamber through a first orifice and partly formed by a first diaphragm, a third liquid chamber connected to the main chamber through a second orifice and formed so that the liquid within the main chamber may be introduced therein, and a balance chamber partitioned through a second diaphragm to the third liquid chamber and formed so that either of a negative pressure and atmospheric pressure may be introduced therein;
wherein the balance chamber is provided with changeover means actuating to change over to either of the negative pressure and the atmospheric pressure continuously or alternately at a specified frequency, and control means controlling the changeover actuation of the changeover means,
the control means being operated under the condition that an idling revolution range of an engine is divided into a low revolution number range and a high revolution number range on the basis of a predetermined conversion point, the control means performing a control action so as to vibrate the second diaphragm in a state synchronized to the vibration frequencies of other orders than a first-order frequency of engine explosive vibrations in said high revolution number range and so as to vibrate the second diaphragm in a state synchronized to the vibration frequencies of other orders than the first-order frequency of the engine explosive vibrations in said low revolution number range.
